(19) United States
(12) Patent Application Publication
(10) Pub. No.: US 2008/0320482 A1
(43) Pub. Date: Dec. 25, 2008

(54) MANAGEMENT OF GRID COMPUTING RESOURCES BASED ON SERVICE LEVEL REQUIREMENTS

(76) Inventors: Christopher J. Dawson, Arlington, VA (US); Roderick E. Legg, Portland, OR (US); Erik Severinghaus, Chicago, IL (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/765,487

(22) Filed: Jun. 20, 2007

(51) Int. Cl. G06F 9/46

(52) U.S. Cl. 718/104

(57) ABSTRACT

Generally speaking, systems, methods and media for management of grid computing resources based on service level requirements are disclosed. Embodiments of a method for scheduling a task on a grid computing system may include updating a job model by determining currently requested tasks and projecting future task submissions and updating a resource model by determining currently available resources and projecting future resource availability. The method may also include updating a financial model based on the job model, resource model, and one or more service level requirements of an SLA associated with the task, where the financial model includes an indication of costs of a task based on the service level requirements. The method may also include scheduling performance of the task based on the updated financial model and determining whether the scheduled performance satisfies the service level requirements of the task and, if not, performing a remedial action.

### FIELD OF INVENTION

The present invention is in the field of data processing systems and, in particular, to systems, methods and media for managing grid computing resources based on service level requirements.

### BACKGROUND

Computer systems are well known in the art and have attained widespread use for providing computer power to many segments of today's modern society. As advances in semiconductor processing and computer architecture continue to push the performance of computer hardware higher, more sophisticated computer software has evolved to take advantage of the higher performance of the hardware, resulting in computer systems that continue to increase in complexity and power. Computer systems have thus evolved into extremely sophisticated devices that may be found in many different settings.

Network data processing systems are commonly used in all aspects of business and research. These networks are used for communicating data and ideas, as well as providing a repository to store information. In many cases, the different nodes making up a network data processing system may be employed to process information. Individual nodes may be assigned different tasks to perform to works towards solving a common problem, such as a complex calculation A set of nodes participating in a resource sharing scheme are also referred to as a “grid” or “grid network”. Nodes in a grid network, for example, may share processing resources to perform complex computations such as deciphering keys.

The nodes in a grid network may be contained within a network data processing system such as a local area network (LAN) or a wide area network (WAN). The nodes may also be located in geographically diverse locations such as when different computers connected to the Internet provide processing resources to a grid network.

The setup and management of grids are facilitated through the use of software such as that provided by Globus® Toolkit (promulgated by the open source Globus Alliance) and International Business Machine, Inc.'s (IBM's) IBM® Grid Toolbox for multiplatform computing. These software tools typically include software services and libraries for resource monitoring, discovery, and management as well as security and file management.

Resources in a grid may provide grid services to different clients. A grid service may typically use a pool of servers to provide a best-efforts allocation of server resources to incoming requests. In many installations, numerous types of grid clients may be present and each may have different business priorities or requirements. Often, to help accommodate different users and their needs, a grid network manager may enter Service Level Agreements (SLAs) with grid clients that specify what level of service will be provided as well as any penalties for failing to provide that level of service.

In the current art, the resources available to a grid are typically computed manually based on priority, time submitted, and job type. This created rigidity in what should be a flexibly and dynamic infrastructure. Consider, for example, two jobs submitted simultaneously to a grid for processing: Job A is submitted 12 hours before it must complete, is very high priority, and takes 10 hours to complete; Job B is submitted 3 hours before it must complete, is lower priority than Job A, and takes 2 hours to complete. In the current art, Job A would be run first because of its priority level and complete in 10 hours. At hour 10, Job B will begin work and complete at hour 12, nine hours after it is due for completion. In this case, the grid scheduler is not able to forecast that Job B should pre-empt Job A to reduce SLA failure.

To solve this problem, grid managers may intervene and manually set Job B to complete before Job A. By introducing manual intervention, however, the risk of error increases and an additional burden is placed on a likely over-stretched grid manager. Moreover, if Job B is manually forced to run first and resources drop from the grid, Job B may take too much time and potentially cause the high priority Job A to miss its SLA. As grid networks become larger and more sophisticated, the problems with manual control of job priority are likely to become even more exacerbated.

### SUMMARY OF THE INVENTION

The problems identified above are in large part addressed by systems, methods and media for management of grid computing resources based on service level requirements. Embodiments of a method for scheduling a task on a grid computing system may include updating a job model by determining currently requested tasks and projecting future task submissions and updating a resource model by determining currently available resources and projecting future resource availability. The method may also include updating a financial model based on the job model, resource model, and one or more service level requirements of a service level agreement (SLA) associated with the task, where the financial model includes an indication of costs of a task based on the service level requirements. The method may also include scheduling performance of the task based on the updated financial model and determining whether the scheduled performance satisfies the service level requirements of the task and, if not, performing a remedial action.

Another embodiment provides a computer program product comprising a computer-useable medium having a computer readable program wherein the computer readable program, when executed on a computer, causes the computer to perform a series of operations for management of grid computing resources based on service level requirements. The series of operations generally includes scheduling a task on a grid computing system may include updating a job model by determining currently requested tasks and projecting future task submissions and updating a resource model by determining currently available resources and projecting future resource availability. The series of operations may also include updating a financial model based on the job model, resource model, and one or more service level requirements of an SLA associated with the task, where the financial model includes an indication of costs of a task based on the service level requirements. The series of operations may also include scheduling performance of the task based on the updated financial model and determining whether the scheduled performance satisfies the service level requirements of the task and, if not, performing a remedial action.

A further embodiment provides a grid resource manager system. The grid resource manager system may include a client interface module to receive a request to perform a task from a client and a resource interface module to send commands to perform tasks to one or more resources of a grid computing system. The grid resource manager system may also include a grid agent to schedule tasks to be performed by the one or more resources. The grid agent may include a resource modeler to determine current resource availability and to project future resource availability and a job modeler to determine currently requested tasks and to project future task submission. The grid agent may also include a financial modeler to determine costs associated with a task based one or more service level requirements of an SLA associated with the task and a grid scheduler to schedule performance of the task based on the costs associated with the task.

### BRIEF DESCRIPTION OF THE DRAWINGS

Aspects of certain embodiments of the invention will become apparent upon reading the following detailed description and upon reference to the accompanying drawings in which like references may indicate similar elements:

FIG. 1 depicts an environment for a grid resource management system with a client, a plurality of resources, a service level agreement database, and a server with a grid resource manager according to some embodiments;

FIG. 2 depicts a block diagram of one embodiment of a computer system suitable for use as a component of the grid resource management system;

FIG. 3 depicts a conceptual illustration of software components of a grid resource manager according to some embodiments;

FIG. 4 depicts an example of a flow chart for scheduling a task in a grid computing management system according to some embodiments;

FIG. 5 depicts an example of a flow chart for updating a resource model according to some embodiments;

FIG. 6 depicts an example of a flow chart for updating a job model according to some embodiments; and

FIG. 7 depicts an example of a flow chart for analyzing the financial impact of task performance and associated SLAs according to some embodiments.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The descriptions below are designed to make such embodiments obvious to a person of ordinary skill in the art.

Generally speaking, systems, methods and media for management of grid computing resources based on service level requirements. Embodiments of a method for scheduling a task on a grid computing system may include updating a job model by determining currently requested tasks and projecting future task submissions and updating a resource model by determining currently available resources and projecting future resource availability. The method may also include updating a financial model based on the job model, resource model, and one or more service level requirements of a service level agreement (SLA) associated with the task, where the financial model includes an indication of costs of a task based on the service level requirements. The method may also include scheduling performance of the task based on the updated financial model and determining whether the scheduled performance satisfies the service level requirements of the task and, if not, performing a remedial action.

The system and methodology of the disclosed embodiments provides for managing the scheduling of tasks in a grid computing system based on deadline-based scheduling by considering the ramifications of violating service level agreements (SLAs). By considering the cost of violating SLAs as well as projected demand and resources, individual tasks may be efficiently scheduled for performance by resources of the grid computing system. The system may also monitor continued performance of a task and, in the event that the probability of the job being completed on time drops below a configurable threshold, the user may be notified and given the opportunity of taking action such as assigning more resources or cancelling the submitted job.

In general, the routines executed to implement the embodiments of the invention, may be part of a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

While specific embodiments will be described below with reference to particular configurations of hardware and/or software, those of skill in the art will realize that embodiments of the present invention may advantageously be implemented with other substantially equivalent hardware, software systems, manual operations, or any combination of any or all of these. The invention can take the form of an entirely hardware embodiment, an entirely software embodiment or an embodiment containing both hardware and software elements. In a preferred embodiment, the invention is implemented in software, which includes but it not limited to firmware, resident software, microcode, etc.

Aspects of the invention described herein may be stored or distributed on computer-readable medium as well as distributed electronically over the Internet or over other networks, including wireless networks. Data structures and transmission of data (including wireless transmission) particular to aspects of the invention are also encompassed within the scope of the invention. Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Each software program described herein may be operated on any type of data processing system, such as a personal computer, server, etc. A data processing system suitable for storing and/or executing program code may include at least one processor coupled directly or indirectly to memory elements through a system bus. The memory elements may include local memory employed during execution of the program code, bulk storage, and cache memories which provide temporary storage of at least some program code in order to reduce the number of times code must be retrieved from bulk storage during execution. Input/output (I/O) devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices though intervening private or public networks, including wireless networks. Modems, cable modems and Ethernet cards are just a few of the currently available types of network adapters.

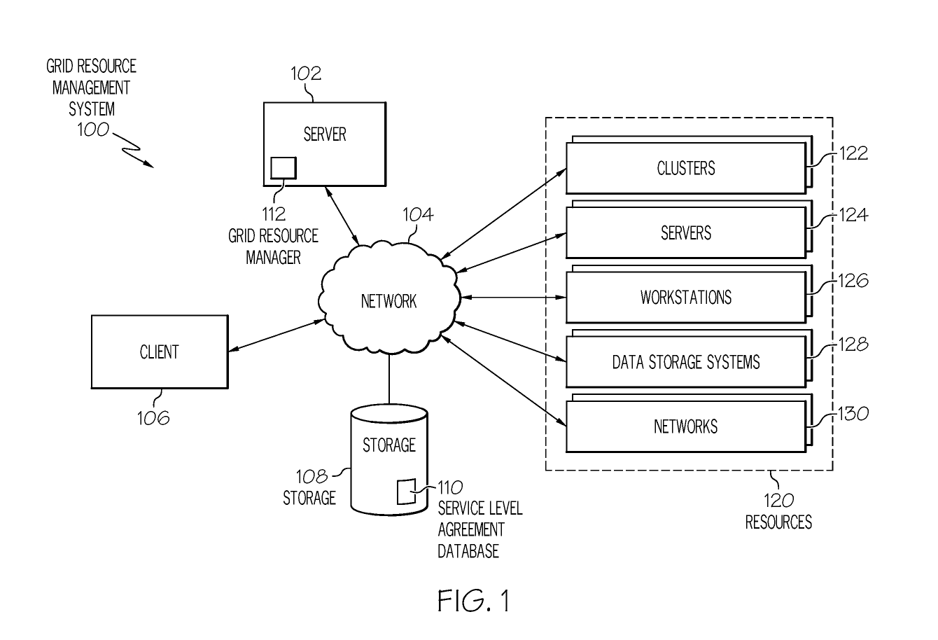

Turning now to the drawings, FIG. 1 depicts an environment for a grid resource management system with a client, a plurality of resources, a service level agreement database, and a server with a grid resource manager according to some embodiments. In the depicted embodiment, the grid resource management system 100 includes a server 102, a client 106, storage 108, and resources 120 in communication via network 104. The server 102 (and its grid resource manager 112) may receive requests from clients 106 to perform or execute tasks on the resources 120 of a grid computing system. As will be described in more detail subsequently, the grid resource manager 112 may advantageously utilize information about service level agreements (stored in storage 108) in scheduling the performance of various tasks on the resources 120.

In the grid resource management system 100, the components may be located at the same location, such as in the same building or computer lab, or could be remote. While the term “remote” is used with reference to the distance between the components of the grid resource management system 100, the term is used in the sense of indicating separation of some sort, rather than in the sense of indicating a large physical distance between the systems. For example, any of the components of the grid resource management system 100 may be physically adjacent or located as part of the same computer system in some network arrangements. In some embodiments, for example, the server 102 and some resources 120 may be located within the same facility, while other resources 120 may be geographically distant from the server 102 (though connected via network 104).

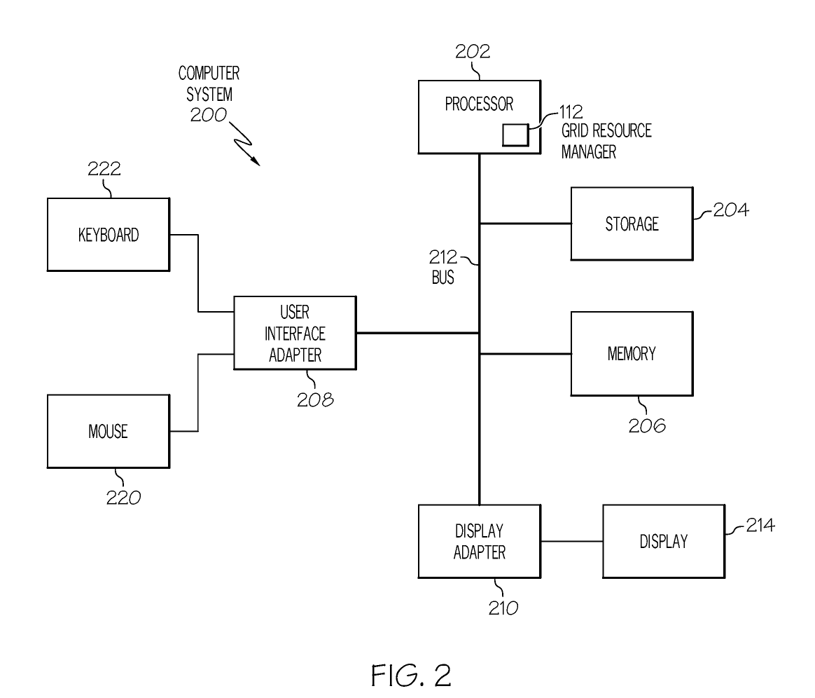

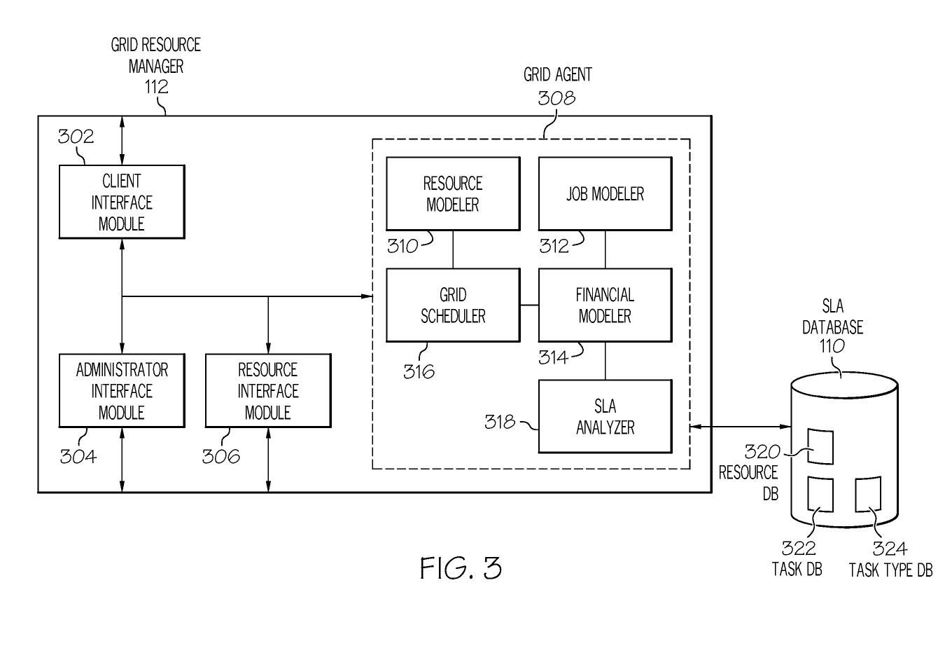

Server 102, which executes the grid resource manager 112, may be implemented on one or more server computer systems such as an International Business Machine Corporation (IBM) IBM Websphere®t application server as well as any other type of computer system (such as described in relation to FIG. 2). The grid resource manager 112, as will be described in more detail subsequently in relation to FIGS. 3-7, may update job models and resource models based on current and projected tasks and resources, respectively, in order to determine a financial model based on service level requirements of an SLA associated with the any tasks requested to be scheduled. The grid resource manager 112 may also schedule performance of each task based on the updated financial model and determine if the scheduled performances satisfy the relevant service level requirements and, if not, may perform a remedial action such as warning a user or assigning additional resources. Server 102 may be in communication with network 104 for transmitting and receiving information.

Network 104 may be any type of data communications channel or combination of channels, such as the Internet, an intranet, a LAN, a WAN, an Ethernet network, a wireless network, telephone network, a proprietary network, or a broadband cable network. In one example, a LAN may be particularly useful as a network 104 between a server 102 and various resources 120 in a corporate environment in situations where the resources 120 are internal to the organization, while in other examples network 104 may connect a server 102 with resources 120 or clients 106 with the Internet serving as network 104, as would be useful for more distributed grid resource management systems 100. Those skilled in the art will recognize, however, that the invention described herein may be implemented utilizing any type or combination of data communications channel(s) without departure from the scope and spirit of the invention.

Users may utilize a client computer system 106 according to the present embodiments to request performance of a task on the grid computing system 102 by submitting such request to the grid resource manager 112 of the server 102. Client computer system 106 may be a personal computer system or other computer system adapted to execute computer programs, such as a personal computer, workstation, server, notebook or laptop computer, desktop computer, personal digital assistant (PDA), mobile phone, wireless device, set-top box, as well as any other type of computer system (such as described in relation to FIG. 2). A user may interact with the client computer system 106 via a user interface to, for example, request access to a server 102 for performance of a task or to receive information from the grid resource manager 112 regarding their task, such as warnings that service level requirements will not be met or a notification of a completed task. Client computer system 106 may be in communication with network 104 for transmitting and receiving information.

Storage 108 may contain a service level agreement database 110 containing information a resource database, a task database, and a task type database, as will be described in more detail in relation to FIG. 3. Storage 108 may include any type or combination of storage devices, including volatile or non-volatile storage such as hard drives, storage area networks, memory, fixed or removable storage, or other storage devices. The grid resource manager 112 may utilize the contents of the SLA database 110 to create and update models, schedule a requested task, or perform other actions. Storage 108 may be located in a variety of positions with the grid resource management system 100, such as being a stand-alone component or as part of the server 102 or its grid resource manager 112.

Resources 120 may include a plurality of computer resources, including computational or processing resources, storage resources, network resources, or any other type of resources. Example resources include clusters 122, servers 124, workstations 126, data storage systems 128, and networks 130. One or more of the resources 120 may be utilized to perform a requested task for a user. The performance of all or part of such tasks may be assigned a cost by the manager of the resources 120 and this cost may be utilized in creating and updating the financial model, as will be described subsequently. The various resources 120 may be located within the same computer system or may be distributed geographically. The grid resource manager 112 and the resources 120 together form a grid computing system to distribute computational and other elements of a task across multiple resources 120. Each resource 120 may be a computer system executing an instance of a grid client that is in communication with the grid resource manager 112.

The disclosed system may provide for intelligent deadline-based scheduling using a pre-determined set of SLAs associated with each task or job. The grid resource manager 112 may forecast what resources may be available as well as forecasting what additional demand will be put on the grid in order to schedule a particular task. By utilizing the forecasted resources and demands as well the costs of failing to meet service level requirements, the grid resource manager 112 may efficiently schedule tasks for performance by the various resources 120. The grid resource manager 112 of some embodiments may also modify the scheduled performance of a task in response to changes in demands, resources, or service level requirements. The grid resource manager 112 may schedule based on completion time, or deadline-based scheduling, instead of submitted time, by taking advantage of the forecasted resources and demand.

The grid resource manager 112 may also monitor demand and resources during performance of a task to determine the likelihood of satisfying service level requirements and to determine if remedial action, such as warning a user or dedicating additional resources, is necessary. If, for example, the probability of a certain job being completed on time drops below a configurable threshold, the user may be notified and given the opportunity to take actions, including assigning addition resources or canceling the submission.

FIG. 2 depicts a block diagram of one embodiment of a computer system 200 suitable for use as a component of the grid resource management system 100. Other possibilities for the computer system 200 are possible, including a computer having capabilities other than those ascribed herein and possibly beyond those capabilities, and they may, in other embodiments, be any combination of processing devices such as workstations, servers, mainframe computers, notebook or laptop computers, desktop computers, PDAs, mobile phones, wireless devices, set-top boxes, or the like. At least certain of the components of computer system 200 may be mounted on a multi-layer planar or motherboard (which may itself be mounted on the chassis) to provide a means for electrically interconnecting the components of the computer system 200. Computer system 200 may be utilized to implement one or more servers 102, clients 106, and/or resources 120.

In the depicted embodiment, the computer system 200 includes a processor 202, storage 204, memory 206, a user interface adapter 208, and a display adapter 210 connected to a bus 212 or other interconnect. The bus 212 facilitates communication between the processor 202 and other components of the computer system 200, as well as communication between components. Processor 202 may include one or more system central processing units (CPUs) or processors to execute instructions, such as an IBM® PowerPC™ processor, an Intel Pentium® processor, an Advanced Micro Devices Inc. processor or any other suitable processor. The processor 202 may utilize storage 204, which may be non-volatile storage such as one or more hard drives, tape drives, diskette drives, CD-ROM drive, DVD-ROM drive, or the like. The processor 202 may also be connected to memory 206 via bus 212, such as via a memory controller hub (MCH). System memory 206 may include volatile memory such as random access memory (RAM) or double data rate (DDR) synchronous dynamic random access memory (SDRAM). In the disclosed systems, for example, a processor 202 may execute instructions to perform functions of the grid resource manager 112, such as by interacting with a client 106 or creating and updating models, and may temporarily or permanently store information during its calculations or results after calculations in storage 204 or memory 206. All of part of the grid resource manager 112, for example, may be stored in memory 206 during execution of its routines.

The user interface adapter 208 may connect the processor 202 with user interface devices such as a mouse 220 or keyboard 222. The user interface adapter 208 may also connect with other types of user input devices, such as touch pads, touch sensitive screens, electronic pens, microphones, etc. A user of a client 106 requesting performance of task of the grid resource manager 112, for example, may utilize the keyboard 222 and mouse 220 to interact with the computer system 200. The bus 212 may also connect the processor 202 to a display, such as an LCD display or CRT monitor, via the display adapter 210.

FIG. 3 depicts a conceptual illustration of software components of a grid resource manager 112 according to some embodiments. As described previously (and in more detail in relation to FIGS. 3-7), the grid resource manager 112 may interact with a client 106, create and update various models, and schedule a task based at least in part on service level requirements for the task from an associated SLA. The grid resource manager 112 may include a client interface module 302, an administrator interface module 306, a resource interface module 306, and a grid agent 308. The grid resource manager 112 may also be in communication with an SLA database 110 and its resource database 320, task database 322, and task type database 324, described subsequently.

The client interface module 302 may provide for communication to and from a user of a client 106, including receiving requests for the performance of a task and transmitting alerts, notifications of completion of a task, or other messages. The administrator interface module 304 may serve as an interface between the grid resource manager 112 and an administrator of the grid computing system. As such, the administrator interface module 304 may receive requests for updates, requests to add or remove resources 120, add or remove clients 106 from the system, or other information. The administrator interface module 304 may also communicate updates, generate reports, transmit alerts or notifications, or otherwise provide information to the administrator. The resource interface module 306 may provide for communication to and from various resources 120, including transmitting instructions to perform a task or commands to start or stop operation as well as receiving information about the current status of a particular resource 120.

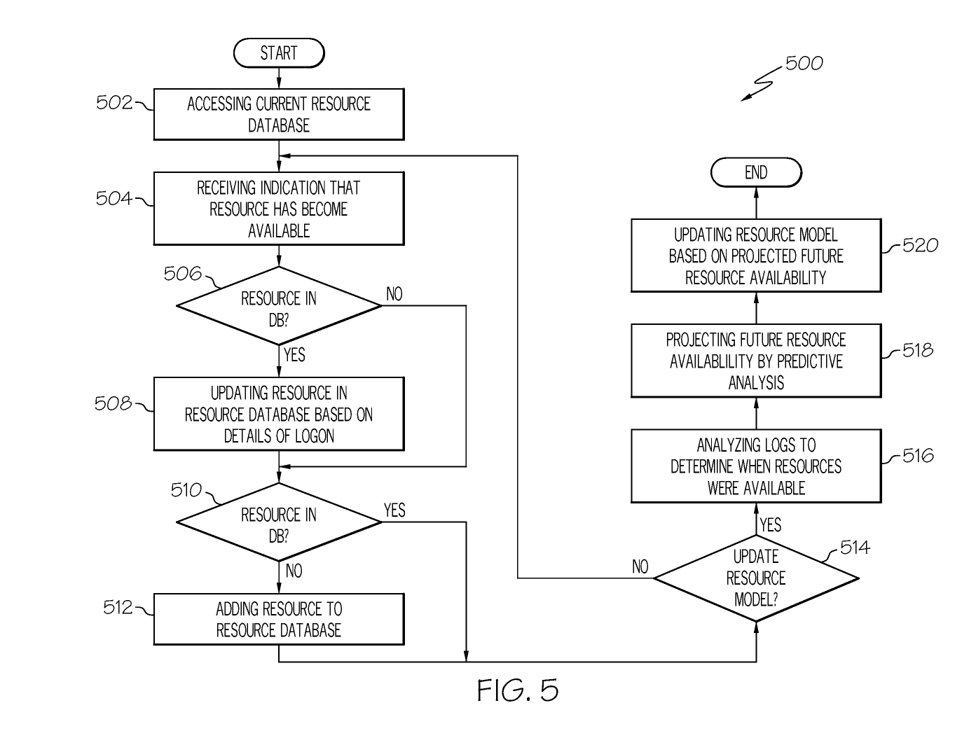

The grid agent 308 may provide a variety of functions to facilitate scheduling a task according to the present embodiments. The disclosed grid agent 308 includes a resource modeler 310, a job modeler 312, a financial modeler 314, a grid scheduler 314, and an SLA analyzer 318. The resource modeler 310, as will be described in more detail in relation to FIG. 5, may create and update a resource model based on both current conditions as well as forecasted conditions. Each time a resource 120 logs on (i.e., becomes available for grid computing), the resource ID of the resource 120 may be noted and an entry may be made to record the logon event. The entry may include information such as the date, time of day, day of week, or other information regarding the logon. The information may be stored in the resource database 320 for later analysis in creating the resource model. The resource database 320 may also include basic information about each resource 120, such as architecture, operating system, CPU type, memory, hard disk drive space, network card or capacity, average transfer speed, and network latency.

The resource modeler 310 may create and update the resource model by running through the logs to determine when each resource 120 was available. Such a scan may be performed at configurable intervals, such as nightly, according to some embodiments. The resource modeler 310 may then analyze the logs to project when each resource will be available and unavailable in the next interval. In some embodiments, the resource modeler 310 may utilize predictive analysis techniques (such as regression) that weight more recent data higher than less recent data to perform its analysis. Such an analysis may be performed at any time, such as at a particular time or date or day of week to ensure that daily, weekly, quarterly, and yearly cycles are all captured and analyzed for the projections. The resource modeler 310 may thus, for example, determine that many scavenged workstation resources 120 tend to be available after close of business (or on the weekends) or every year on major holidays.

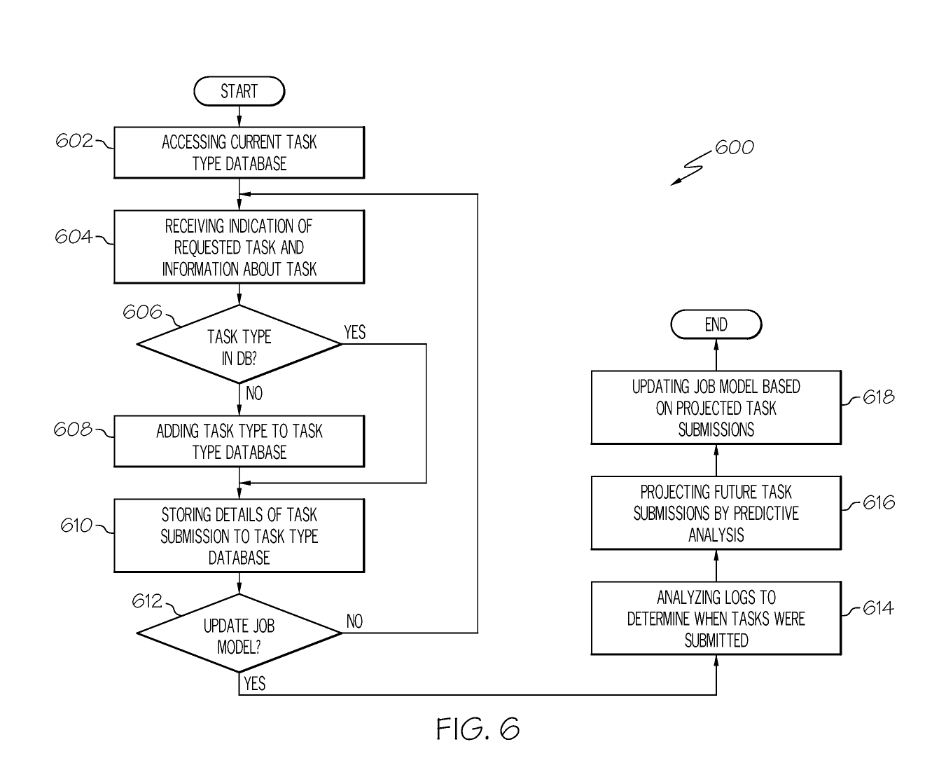

The job modeler 312, as will be described in more detail in relation to FIG. 6, may create and update a job model based on both current demand as well as forecasted demand. Each time a discrete task is requested by a client 106, the job modeler 312 may record basic information for each job in the task database 322. Basic information about a task may include the associated SLA, the cost of failure, run time, deadline, internal information about a task or client 106, or other information. The job modeler 312 may, similarly to the resource modeler 310, analyze the task information stored in the task database 322 to determine the likelihood of additional demand on grid resources (i.e., projecting demand). The job modeler 312 may also utilize the task type database 324 for general information about a particular task type, including the costs of failing to meet SLA service level requirements. The job modeler 312 may use predictive analysis techniques or other techniques to make its determination. A job modeler 312 could, for example, determine that every Monday a department runs a high-priority task or that on the first day of every month a large task is run.

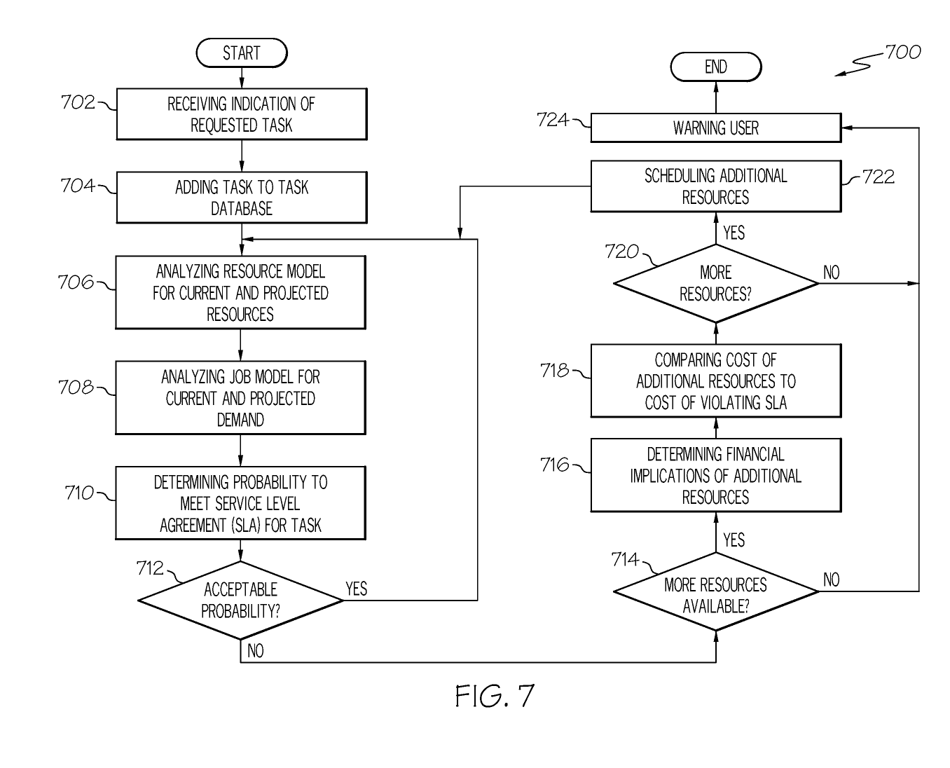

The financial modeler 314, as described in more detail in relation to FIGS. 5 and 7, may utilize the updated resource model and job model and optimize which resources 120 should run each task based on the costs of failing to meet service level requirements. The financial modeler 314 may utilize the SLA analyzer 318 to analyze the service level requirements of an SLA to determine the costs of failing to meet any service level requirements in order to create or update the financial model. The financial model itself may include information about the cost of adding additional resources, the cost of failing to meet service level requirements, information about whether the SLA may be customized, or other financial information.

The grid scheduler 316 may schedule tasks for performance on various resources 120 based on the updated financial model produced by the financial modeler. The grid scheduler 316 may, for example, determine that delaying performance of a task such that it violates service level requirements is less expensive than bring on new resources 120 and thus may authorize an SLA violation. If it is likely that service level requirements will be violated, the grid scheduler 316 may perform a remedial action such as adding additional resources 120 or notifying the user and receiving authorization to modify the SLA, add resources, delay or cancel the task, or other action.

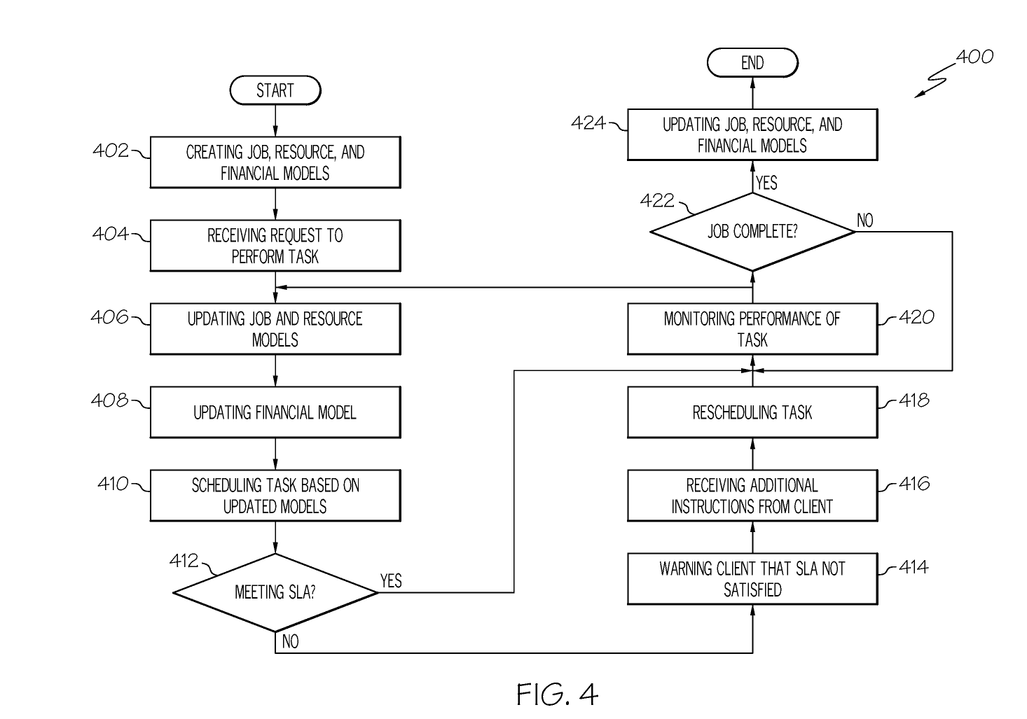

FIG. 4 depicts an example of a flow chart 400 for scheduling a task in a grid computing management system according to some embodiments. The method of flow chart 400 may be performed, in one embodiment, by components of the grid resource manager 112, such as the grid agent 308. Flow chart 400 begins with element 402, creating demand, resource and financial models. At element 402, the modelers 310, 312, 314 of the grid agent 308 may create the initial versions of the resource, job, and financial models, respectively. At element 404, the grid resource manager 112 may receive a request from a client 106 to perform a task on the grid.

Once a task request is received, the resource modeler 310 and job modeler 312 may at element 406 update the resource and job models, respectively. Element 406 may be performed upon request, after receive a task request, or at scheduled intervals according to some embodiments. The financial modeler 314 may at element 408 update the financial model based on the updated job and resource models. The updated financial model may provide an indication of, among other things, the costs of failing to meet the SLA associated with the task.

The grid scheduler 316 of the grid agent 308 may at element 410 schedule the task based on the updated resource, job, and financial models. The grid scheduler 316 may as part of the analysis determine at decision block 412 whether the scheduled performance of the task will meet the SLA with a satisfactory level of probability. The grid scheduler 316 may perform this analysis utilizing the projected resources 120 and task requests from the updated models. If the SLA will not be met, the grid agent 108 may warn the client 106 that one or more service level requirements of the SLA will not be met at element 414. The grid scheduler 316 may receive an indication of additional instructions from the client 106 at element 416, such as a request to change the SLA to increase the priority of the task, change the SLA to relax the deadline of the task, cancel the task, or otherwise modify its performance requirements. If the task is to be rescheduled, the grid scheduler 316 may reschedule the task at element 418.

If the task is determined to be meeting the SLA (or if it has been rescheduled to do so), the grid agent 308 may continue to monitor performance of the task at element 420. To continue monitoring, the grid agent 308 may update the various models (by returning to element 406 for continued processing) and analyze the performance of the task in order to ascertain if it is still meeting its schedule. If it is at risk of no longer meeting its service level requirements (at decision block 412), it may be rescheduled, the user may be warned, etc., as described previously. This may occur during execution of a task if, for example, a higher priority task is later requested that will preempt the original task. If, at decision block 422, the task completes, the job, resource, and financial models may be updated at element 424 to reflect the completed task (and the freeing up of resources 120), after which the method terminates. By continuing to monitor the available resources 120 and demand, the costs of failing to meet service level requirements of various tasks may be effectively and efficiently managed.

FIG. 5 depicts an example of a flow chart 500 for updating a resource model according to some embodiments. The method of flow chart 500 may be performed, in one embodiment, by components of the grid agent 308 such as the resource modeler 310. Flow chart 500 begins with element 502, accessing the current resource database 320. At element 504, the resource modeler 310 may receive an indication that a resource has become available. The resource modeler 310 may determine at decision block 506 whether the resource that is becoming available is already in the resource database 320. If the resource is in the resource database 320, the resource modeler 310 may at element 508 update the resource entry in the resource database with details of the logon, such as the time, date, or day of the week of the logon of the resource 120. If the newly available resource 120 is not in the resource database 320 as determined at decision block 510, the resource modeler 310 may add the resource 120 to the database for future use, along with details of this particular logon by the resource 120. While elements 504 through 512 discuss additional resources 120 logging on, the resource modeler 310 may use a similar methodology for updating the resource database 320 when resources become unavailable.

At decision block 514, the resource modeler 310 may determine whether the resource model needs to be updated, such as when an update is requested, a pre-defined amount of time has passed, or a particular event has occurred (e.g., a new requested task). If no update is required, the method of flow chart 500 may return to element 504 for continued processing. If the resource model is to be updated, the resource modeler 310 may at element 516 analyze the logs stored in the resource database 320 to determine when resources were available, such as based on time of day, day of week, day of month or year, etc. The resource modeler 310 may at element 518 project the future resource availability based on the analyzed logs using predictive analysis or other methodology. The resource modeler 310 may then at element 520 update the resource model based on the projected future resource availability, after which the method terminates.

FIG. 6 depicts an example of a flow chart 600 for updating a job model according to some embodiments. The method of flow chart 600 may be performed, in one embodiment, by components of the grid agent 308 such as the job modeler 312. Flow chart 600 begins with element 602, accessing the current task type database 324. At element 604, the job modeler 312 may receive an indication that a new task has been requested and also receive information about the task. The job modeler 310 may determine at decision block 606 whether the task type of the requested task is already in the task type database 324. If the task type is not in the task type database 324, the job modeler 312 may at element 608 update the task type database with the new type of task. At element 610, the job modeler 312 may store details of the particular task submission to the task database 322. Task details may include the priority of the task, date of submission, date or day of week of submission, or other information.

At decision block 612, the job modeler 312 may determine whether the job model needs to be updated, such as when an update is requested, a pre-defined amount of time has passed, or a particular event has occurred (e.g., a new requested task). If no update is required, the method of flow chart 600 may return to element 604 for continued processing. If the job model is to be updated, the job modeler 312 may at element 614 analyze the logs stored in the task database 322 to determine when tasks were submitted, such as based on time of day, day of week, day of month or year, etc. The job modeler 310 may at element 616 project the future task submissions based on the analyzed logs using predictive analysis or other methodology. The job modeler 312 may then at element 618 update the job model based on the projected future task submissions, after which the method terminates.

FIG. 7 depicts an example of a flow chart 700 for analyzing the financial impact of task performance and associated SLAs according to some embodiments. The method of flow chart 700 may be performed, in one embodiment, by components of the grid resource manager 112, such as the grid agent 308. Flow chart 700 begins with element 702, receiving an indication of the requested task from a client 106. At element 704, the grid agent 308 may add the task (and information related to its submittal) to the task database 322.

The financial modeler 314 and the grid scheduler 316 may together analyze the various models, determine the relative costs of meeting or failing to meet service level requirements, and schedule the task. At element 706, the resource model may be analyzed to determine the current and projected resources 120 for performing tasks. Similarly, at element 708, the job model may be analyzed to determine the current and projected tasks, or demand for resources 120. Based on these analyses, at element 710, the probability of meeting the service level requirements for the task may be determined. If, at decision block 712, there is an acceptable level of probability of meeting the SLA, the method returns to element 706 for continued processing.

If, at decision block 712, there is not an acceptable probability of satisfying the SLA, the financial modeler 314 may determine if more resources 120 are available at decision block 714. If no such resources 120 are available, the method continues to element 724 where the user is warned that the SLA will be violated, after which the method terminates. Alternatively, the user may be presented with options such as increasing their priority, canceling the job, etc. If resources 120 are available, the financial modeler 314 may at element 716 determine the financial implications of additional resources and may at element 718 compare the cost of the additional resources to the cost of violating the SLA. Based on this comparison, the grid scheduler 316 may at decision block 720 determine whether to dedicate more resources 120 to the task. The grid scheduler 316 may decide, for example, to dedicate more resources 120 if the cost of violating the SLA is higher than the cost of additional resources 120 and if no higher priority jobs needing those resources 120 are coming soon. If additional resources 120 will not be dedicated at decision block 720 (the cost of additional resources 120 is too high), the user may be warned at element 724 and the method may then terminate. If more resources 120 will be dedicated, the new resources 120 are scheduled at element 722 and the method may return to element 706 for continued processing.

It will be apparent to those skilled in the art having the benefit of this disclosure that the present invention contemplates methods, systems, and media for management of grid computing resources based on service level requirements. It is understood that the form of the invention shown and described in the detailed description and the drawings are to be taken merely as examples. It is intended that the following claims be interpreted broadly to embrace all the variations of the example embodiments disclosed.

What is claimed is:

1. A method for scheduling a task on a grid computing system, the method comprising:
updating a job model for the grid computing system by determining currently requested tasks and projecting future task submissions;
updating a resource model for the grid computing system by determining currently available resources and projecting future resource availability;
updating a financial model for the grid computing system based on the updated job model, the updated resource model, and one or more service level requirements of a service level agreement (SLA) associated with the task to be scheduled, the financial model including an indication of costs of a task based on the one or more service level requirements;
scheduling performance of the task based on the updated financial model;
determining whether the scheduled performance of the task satisfies the one or more service level requirements associated with the task; and
in response to determining that one or more service level requirements associated with the task are not satisfied, performing a remedial action.

2. The method of claim 1, further comprising receiving a request to perform a task on the grid computing system.

3. The method of claim 1, further comprising monitoring performance of the task during its execution.

4. The method of claim 1, wherein updating the job model for the grid computing system comprises storing details of the requested task to a task type database.

5. The method of claim 1, wherein updating the job model for the grid computing system comprises analyzing logs of requested tasks to determine when tasks were previously submitted and projecting future task submissions by predictive analysis of the analyzed logs of requested tasks.

6. The method of claim 1, wherein updating the resource model for the grid computing system comprises updating a resource in a resource database after the resource logs on.

7. The method of claim 1, wherein updating the resource model for the grid computing system comprises analyzing logs of resource availability to determine when resources were previously available and projecting future resource availability by predictive analysis of the analyzed logs of resource availability.

8. The method of claim 1, wherein determining whether the scheduled performance of the task satisfies the one or more service level requirements associated with the task comprises determining whether a determined probability of meeting the one or more service level requirements meets or exceeds a pre-determined level of probability.

9. The method of claim 1, wherein performing a remedial action comprises notifying a user who submitted the job that one or more service level requirements will not be satisfied.

10. The method of claim 9, further comprising receiving from the user an indication of a change in service level requirements.

11. The method of claim 1, wherein performing a remedial action comprises scheduling additional resources.

12. A computer program product comprising a computer-useable medium having a computer readable program, wherein the computer readable program when executed on a computer causes the computer to:
updating a job model for the grid computing system by determining currently requested tasks and projecting future task submissions;
updating a resource model for the grid computing system by determining currently available resources and projecting future resource availability;
updating a financial model for the grid computing system based on the updated job model, the updated resource model, and one or more service level requirements of a service level agreement (SLA) associated with the task to be scheduled;
scheduling performance of the task based on the updated financial model;
determining whether the scheduled performance of the task satisfies the one or more service level requirements associated with the task; and
in response to determining that one or more service level requirements associated with the task are not satisfied, performing a remedial action.

13. The computer program product of claim 12, further comprising receiving a request to perform a task on the grid computing system.

14. The computer program product of claim 12, further comprising monitoring performance of the task during its execution.

15. The computer program product of claim 12, wherein updating the job model for the grid computing system comprises analyzing logs of requested tasks to determine when tasks were previously submitted and projecting future task submission by predictive analysis of the analyzed logs of requested tasks.

16. The computer program product of claim 12, wherein updating the resource model for the grid computing system comprises analyzing logs of resource availability to determine when resources were previously available and projecting future resource availability by predictive analysis of the analyzed logs of resource availability.

17. A grid resource manager system implemented on a server, the system comprising:
a client interface module to receive a request to perform a task from a client;
a resource interface module to send commands to perform tasks to one or more resources of a grid computing system; and
a grid agent to schedule tasks to be performed by the one or more resources, the grid agent comprising:
a resource modeler to determine current resource availability and to project future resource availability;
a job modeler to determine currently requested tasks and to project future task submission;
a financial modeler to determine costs associated with a task based on one or more service level requirements of a service level agreement (SLA) associated with the task; and
a grid scheduler to schedule performance of the task based on the costs associated with the task.

18. The system of claim 17, further comprising an SLA database in communication with the grid agent, the SLA database having a resource database, a task database, and a task type database.

19. The system of claim 17, wherein the grid scheduler determines whether the scheduled performance of the task satisfies the one or more service level requirements associated with the task and performs a remedial action in response to determining that the one or more service level requirements will not be satisfied.

20. The system of claim 17, wherein the resources modeler projects future resource availability by predictive analysis of analyzed logs of requested tasks, and wherein further the job modeler projects future task submissions by predictive analysis of analyzed logs of requested tasks.
